(19) United States
(12) Patent Application Publication
(10) Pub. No.: US 2025/0346519 A1
(43) Pub. Date: Nov. 13, 2025

(54) PRESSING DEVICE FOR PREPARING CULTURE DISHES USING FLAT GLASS AND PROCESS THEREOF

(71) Applicants: Wei Hong, Shanghai (CN); Chunjiang Zhang, Shanghai (CN)

(72) Inventors: Wei Hong, Shanghai (CN); Chunjiang Zhang, Shanghai (CN)

(21) Appl. No.: 18/982,968

(22) Filed: Dec. 16, 2024

(30) Foreign Application Priority Data
May 11, 2024 (CN) 2024105799156

(51) Int. Cl. C03B 23/00; C03B 25/06

(52) U.S. Cl. CPC C03B 23/002; C03B 23/0086; C03B 23/0093; C03B 25/06

(57) ABSTRACT

A pressing device for preparing culture dishes using flat glass and a process thereof, utilizing a flat glass bending molding process of high borosilicate glass or soda-lime glass. The prepared culture dish can not only give full play to the excellent physical and chemical properties of high borosilicate glass flat glass or soda-lime glass, but also the flatness of the inner plane of the glass bottom of the culture dish is higher, the product quality is stable, and it is more energy-saving, efficient and high-quality.

### TECHNICAL FIELD

The invention relates to the technical field of culture dish preparation, and in particular to a pressing device for preparing culture dishes using flat glass and a process thereof.

### BACKGROUND ART

As a necessary glassware in the laboratory, glass culture dishes are widely used in the fields of medicine, biology, chemistry, and pharmaceuticals. As the main glassware for culturing cells and bacterial microorganisms, the culture dish consists of a bottom and a cover. The two are of the same shape, except that the diameter of the glass cover is slightly larger than the diameter of the glass bottom, and the vertical height of the glass cover is slightly smaller than the vertical height of the glass bottom. The shape of the culture dish is a disc-shaped glassware with a circumference and a vertical surface, and a flat circular bottom (that is, including the bottom and the vertical surface). The advantages of glass culture dishes are that they can withstand high temperature sterilization (160° C.-180° C.), friction resistance, and repeated use.

Since the 19th century, there have been many ways to produce glass culture dishes. 1. The earliest method was to use glass kilns to blow them manually, which caused great pollution, poor quality and low efficiency. This production method has been gradually eliminated. Now only culture dishes with a diameter greater than 120 mm are still blown manually. 2. In the past decade, due to pollution and energy consumption of small glass kilns, artificially blown culture dishes have gradually withdrawn from the market. Since the market demand for culture dishes is still strong, a technology for producing culture dishes by using high borosilicate glass tubes and sealing the bottom of the glass tubes has begun to appear. This has also alleviated some of the pressure of market demand. However, this method has quality deficiencies and strict requirements on glass materials. It can only be produced using high borosilicate glass tubes with excellent thermal processing properties, and cannot be produced using soda-lime glass plates with lower costs but weak thermal processing properties. This glass tube uses natural gas and oxygen heat sealing. Due to process defects, there are many problems with the products produced by this production method: the flatness of the bottom surface of the glass is very poor, the bottom glass surface is uneven, the glass thickness is uneven, the local thickness difference can differ by 50%, the local glass plane will have a very thin thickness, the uneven glass surface will cause the culture medium to be unstable in the culture dish during the experiment, the uneven thickness of the bottom surface of the glass makes it very easy for laboratory operators to break the culture dish during use and cleaning, and the production efficiency and qualified rate of this production method are not high, the energy consumption is relatively large, and it is not energy-saving and environmentally friendly; the culture dishes produced in this way can only be a transitional product. 3. In addition, there is another type of culture dish produced by welding high borosilicate glass sheets and high borosilicate glass tubes. This process is affected by the low roundness of the glass tube and the unstable precision of the lathe. The glass rings cut from the glass tube are manually welded to the pre-cut glass discs using a glass lathe. The quality of this product is very unstable, which can easily cause uneven glass on the edge of the culture dish, gaps or unevenness at the angle between the glass facade and the glass bottom plane inside the culture dish, which can easily cause dirt to accumulate inside the culture dish and make it impossible to clean it thoroughly, causing contamination to the experimental bacteria and tissue culture, resulting in the failure of the experiment. At the same time, the cost of this manufacturing method is very high, about 5 times that of other production methods, and this production method is also a transitional production process. 4. The lag in the manufacturing process of glass culture dishes has led to the gradual rise of disposable products such as plastic culture dishes in the market. The excessive use of plastic disposable culture dishes is not conducive to the green, environmental protection and sustainable development advocated by the country. During this period, the United States and European countries have begun to use mechanized production methods to produce culture dishes, such as glass blowing machines, machine-blown culture dishes, etc. The overall quality level is an order of magnitude higher than domestic products.

### SUMMARY OF THE INVENTION

Therefore, based on the above background, the invention has developed a pressing device for preparing culture dishes using flat glass and a process thereof. Through the pressing device, culture dishes are prepared by bending flat glass made of high borosilicate glass or soda-lime glass. The excellent physical and chemical properties of high borosilicate glass or soda-lime glass can be brought into play, and the inner plane of the glass bottom of the prepared culture dish has a higher flatness, the angle between the glass facade and the glass bottom plane inside the culture dish is smooth, the glass wall thickness of the facade and its bottom is almost the same, the product quality is stable, and it is more energy-saving, efficient, and high-quality.

The technical solution provided by the invention is:
a pressing device for preparing culture dishes using flat glass, wherein it comprises a pressing mechanism;
the pressing mechanism comprises at least one pressing mould 3, and the pressing mould 3 comprises a support base 32; a center of the support base 32 is provided with a through hole, and a support module 33 is sleeved in the through hole; a lower part of the support module 33 is provided with a rotating lifting mechanism, which can drive the support module to move up and down and perform horizontal rotation;
a top surface of the support base 32 is provided with a cylindrical pressing block 4.

Further, a center of the support module 33 is provided with a negative pressure hole 34, which is connected to a vacuum pump 39 via a negative pressure pipe 310.

Further, the rotating lifting mechanism comprises a first lifting drive mechanism 36 and a first rotating drive mechanism 38;
the first rotating drive mechanism 38 is located below the first lifting drive mechanism 36;
the first rotating drive mechanism 36 comprises a motor and a rotating shaft, and the rotating shaft is provided with a mounting plate 311;
the first lifting drive mechanism and the vacuum pump 310 are mounted on the mounting plate 311;
the first lifting drive mechanism 36 is an electric lifting rod, and the rod body 37 of the first lifting drive mechanism 36 is hollow; the negative pressure pipe 39 passes through part of the rod body 37.

Further, it further comprises a base 1, which comprises a disc 2 that can rotate horizontally; the pressing mould 3 is mounted on the disc 2 at an equal angle.

Further, it further comprises a pressure plate mechanism 8, which comprises a pressure plate bracket 81 and a pressure plate 82.

Further, the pressure plate bracket 81 is provided with a second lifting drive mechanism 83, which can drive the pressure plate 82 to move up and down.

Based on the same inventive concept, the invention further provides a process for preparing culture dishes using flat glass, including the following steps:
S1: preparing flat glass, and cutting the flat glass into glass discs with diameter requirements and neat outer edges according to the bottom diameter and vertical height of the culture dish by an automatic scriber for later use;
S2: preheating the glass discs to 400° C.-600° C. through the metal strip of a preheating furnace;
S3: placing the preheated glass discs on the above pressing mould of the pressing device; controlling the support module 33 to be raised, with partially separated from the through hole of the support base 32 and located below the pressing block 4;
S4: controlling the support base 32 to rotate to drive the glass discs to rotate; when the glass discs are rotating, using a flame spray gun head to heat the edge of the glass discs, and using another flame spray gun head to heat the to be edge-folded portion of the glass discs, wherein the to be edge-folded portion corresponds to the intersection of a bottom and a vertical surface of the culture dish;
S5: continuing to control the support module 33 to rise until a bottom surface of the pressing block 4 presses the glass disc, and then continuing to lift the support module 33; under the force of the pressing block 4, the corresponding to be edge-folded portion of the rotating glass disc is deformed, which drives the vertical surface of the corresponding culture dish to turn down 90 degrees; the glass of the turned-down part is completely attached to the side curved surface of the support module 33; after the vertical surface of the culture dish is formed, continuing to control the support module 33 to rotate horizontally, and then the culture dish blank is manufactured;
S6: controlling the support module 33 to descend until an inner bottom surface of the glass culture dish blank is separated from the support module 33, and the glass culture dish blank is inverted with an opening facing downward and supported by the support base 32;
S7: transferring the culture dish blank to an annealing furnace plate belt, annealing in the annealing kiln, and then gradually reducing the temperature; finally, after leaving the annealing furnace at a temperature of about 80° C., cooling to room temperature to prepare the culture dish.

Further, in step S5, the support module continues to heat the edge of a vertical surface of the culture dish using a flame spray gun head during the process of rotating and rising.

Further, in step S4, the heating temperature of the flame spray gun head is controlled at 850-950° C. (the heating time is related to the rotation speed; it is meaningless to talk about the heating time without considering the rotation speed).

Further, the flat glass may be a borosilicate glass sheet or a soda-lime glass sheet.

The above technical solution has the following beneficial effects:

The flatness of the inner plane of the glass bottom of the culture dish prepared by the invention is related to the flatness of the flat glass, and the flatness of the flat glass is easier to stably control. The flatness of the inner plane of the bottom of the glass of the glass culture dish prepared by the invention can be stably controlled at 0.15 mm/m or above, and its flatness is more than 5 times better than the flatness of the high borosilicate glass culture dishes produced by the bottom sealing method on the market. At the same time, the inner bottom thickness tolerance of the culture dish produced by the glass sheet is less than 0.02 mm. Therefore, the flat glass of high borosilicate glass or soda-lime glass is press-bent and formed by the invention, that is, the flat glass of high borosilicate glass or soda-lime glass is directly used for integral molding. The prepared culture dish can not only give full play to the excellent physical and chemical properties of high borosilicate glass flat glass or soda-lime glass, but also the flatness of the inner plane of the glass bottom of the culture dish is higher, the product quality is stable, and it is more energy-saving, efficient and high-quality.

### BRIEF DESCRIPTION OF THE DRAWINGS

In order to illustrate the technical solution of the invention or the prior art more clearly, the drawings used in the embodiments or the description of the prior art will be briefly introduced hereinafter. It is obvious that the drawings hereinafter are just some of the embodiments of the invention.

FIG. 1 is a first schematic structural diagram of the pressing device according to the invention;

FIG. 2 is a second schematic structural diagram of the pressing device according to the invention;

FIG. 3 is a third schematic structural diagram of the pressing device according to the invention;

FIG. 4 is a first schematic structural diagram of the mould according to the invention;

FIG. 5 is a second schematic structural diagram of the mould according to the invention;

FIG. 6 is a first schematic diagram of the use state of the mould (corresponding to step S3);

FIG. 7 is a second schematic diagram of the use state of the mould (corresponding to step S5);

FIG. 8 is a first structural schematic diagram of the pressing device according to Embodiment 3 of the invention;

FIG. 9 is a second structural schematic diagram of the pressing device according to Embodiment 3 of the invention.

### SPECIFIC EMBODIMENT OF THE INVENTION

In order to make the objectives, technical solutions, and advantages of the embodiments of the invention clearer, the technical solutions in the embodiments of the invention will be described clearly and completely hereinafter with reference to the drawings in the embodiments of the invention. Obviously, the described embodiments are part of the embodiments of the invention, rather than all of the embodiments. Based on the embodiments of the invention, all other embodiments obtained by those of ordinary skill in the art without creative efforts shall fall within the protection scope of the invention.

The invention will be further described hereinafter with reference to the drawings.

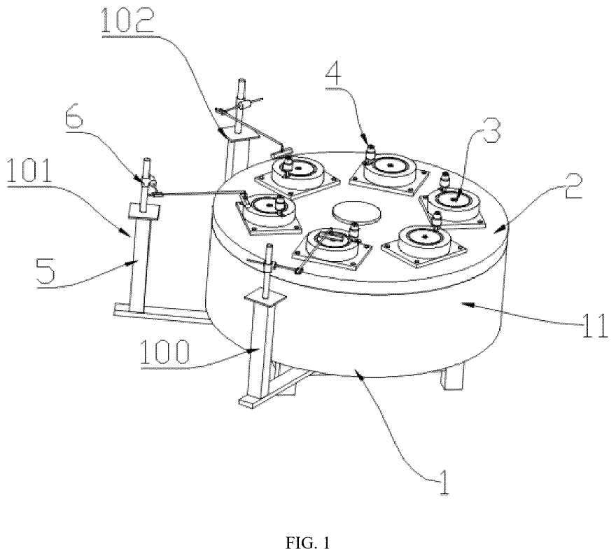

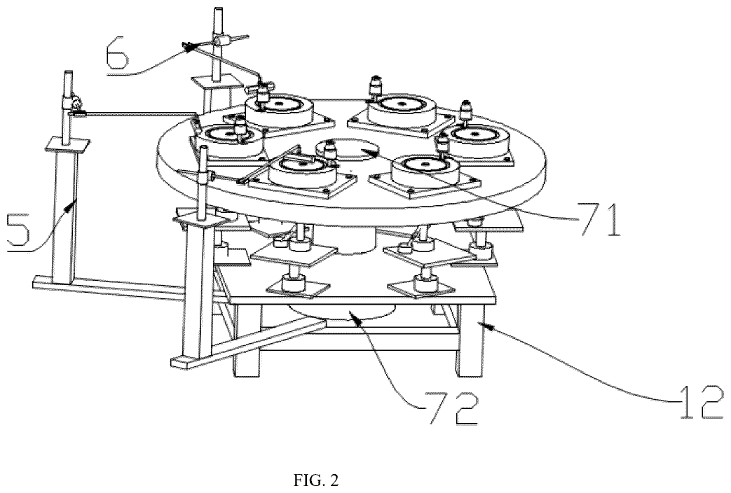

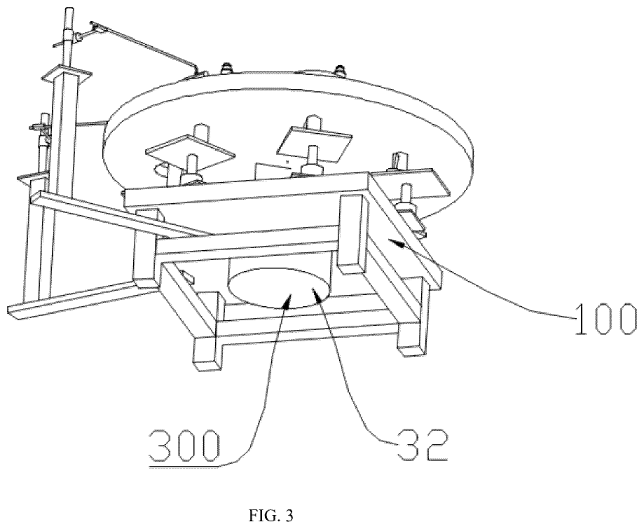

Embodiment 1: a pressing device for preparing culture dishes using flat glass as shown in FIGS. 1-7, wherein:
it comprises a pressing mechanism;
the pressing mechanism comprises at least one pressing mould 3, and the pressing mould comprises a support base 32; a center of the support base 32 is provided with a through hole, and a support module 33 is sleeved in the through hole; a lower part of the support module 33 is provided with a rotating lifting mechanism, which can drive the support module to move up and down and perform horizontal rotation;
a top surface of the support base 32 is provided with a cylindrical pressing block 4. In this embodiment, a support rod with a length is provided below the pressing block 4. For example, the pressing block 4 can be fixed to the support base 32 by bolts, so that the distance between the pressing block 4 and the edge of the glass disc can be adjusted as needed. The pressing block is made of graphite or heat-resistant stainless steel.

A center of the support module 33 is provided with a negative pressure hole 34, which is connected to a vacuum pump 310 via a negative pressure pipe 39. The glass discs can be stably placed on the support module 33 by the negative suction effect of the negative pressure pump.

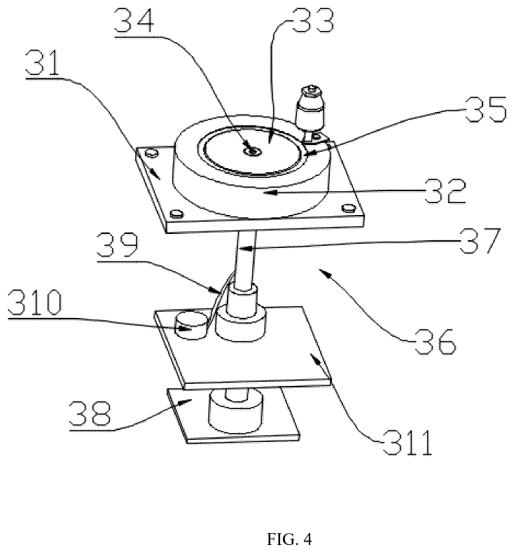

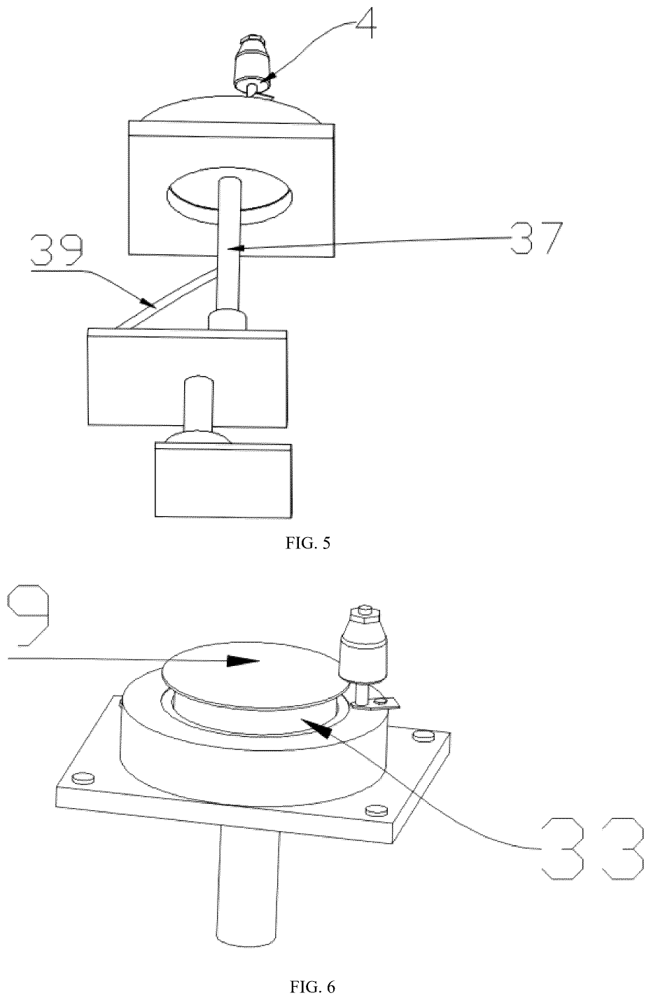

The rotating lifting mechanism comprises a first lifting drive mechanism 36 and a first rotating drive mechanism 38; the first rotating drive mechanism 38 is located below the first lifting drive mechanism 36; the first rotating drive mechanism 36 comprises a motor and a rotating shaft, and the rotating shaft is provided with a mounting plate 311; the first lifting drive mechanism and the vacuum pump 310 are mounted on the mounting plate 311; the first rotating drive mechanism can drive the first lifting drive mechanism, the vacuum pump, and the support module 33 to rotate together, so as to prevent the negative pressure pipe from being entangled or pulled. The first lifting drive mechanism 36 is an electric lifting rod, and the rod body of the first lifting drive mechanism 36 is hollow; the negative pressure pipe 39 passes through part of the rod body 37. As shown in FIGS. 4 and 5, a feasible method is that the negative pressure hole 34 passes through the support module 33, part of the negative pressure pipe 39 is a hard tube section, the hard tube section is embedded in the support module 33 and passes through part of the rod body, and the part of the negative pressure pipe located outside the rod body has a hose section or a bellows section to adapt to the negative pressure pipe rising and falling with the rod body.

The pressing mould may be one or more than one. In this embodiment, there is one pressing mould, and only one culture dish is processed and prepared at a time.

Embodiment 2: a pressing device for preparing culture dishes using flat glass as shown in FIGS. 1-7, compared with Embodiment 1, it further comprises a base 1, which comprises a disc 2 that can rotate horizontally, and the disc 2 is driven by a second rotating drive mechanism 7 to rotate horizontally;
the pressing mould 3 is mounted on the disc 2 at an equal angle. Specifically, the support base 32 is mounted on the disc 2 through a fixed base plate 31. In this embodiment, the fixed base plate 31 can be mounted on the disc by bolts.

As shown in FIGS. 1-3, the second rotating drive mechanism 7 comprises a driving shaft 71 and a rotating drive motor 72; the rotating drive motor is mounted on the support base 12 of the base, and the free end of the driving shaft 71 is connected to the disc 2. A cover plate 11 is fixed below the disc by bolts.

The number of the pressing moulds 3 of this embodiment can be more than one. For example, as shown in the figure, when the number of the pressing moulds is 6, the angle between adjacent moulds is 60 degrees. Of course, the number of the pressing moulds is not limited to the above. For example, it can be 1 or 2 or 3, or more than 6. The specific number of moulds can be set according to the production scale. The setting of multiple pressing molds of the invention can simultaneously process multiple glass discs to prepare culture dishes, which is efficient.

More specifically, the discs are provided with flame spray gun mechanisms, which comprise a first flame spray gun 100, a second flame spray gun 101, and a third flame spray gun 102, which are adjacent to each other at equal angles; the included angles among the first flame spray gun 100, the second flame spray gun 101, and the third flame spray gun 102 are consistent with the included angle of the pressing moulds, that is, the included angles among adjacent flame spray guns are consistent with the included angles between the pressing moulds. The flame spray gun heads of the first flame spray gun 100, the second flame spray gun 101, and the third flame spray gun 102 are respectively mounted on an adjustment bracket 6, and the adjustment bracket 6 is mounted on a support frame 5; the adjustment bracket can adjust the height, angle and upper position of the flame spray gun head toward the disc, which is prior art, such as the “A Flame Spray Gun Fixing Bracket and A Fixing Device” disclosed in application No. 2021221010259, so it will not be elaborated.

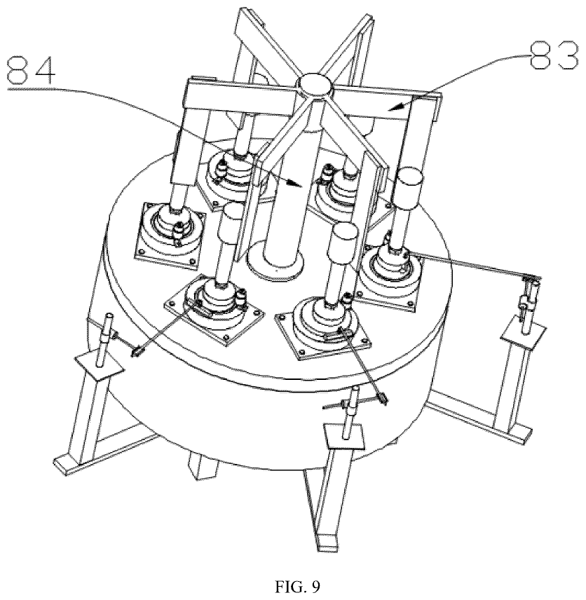

Embodiment 3: a pressing device for preparing culture dishes using flat glass as shown in FIGS. 1-9, compared with Embodiment 2, it further comprises a pressure plate mechanism 8, which comprises a pressure plate bracket 81 and a pressure plate 82.

The pressure plate bracket 81 is provided with a second lifting drive mechanism 83, which can drive the pressure plate 82 to move up and down.

The second lifting drive mechanism 83 can be a screw lifting mechanism or an electric push rod mechanism. The second lifting drive mechanism of this embodiment adopts an electric push rod mechanism. The second lifting drive mechanism controls the lifting and lowering of the pressure plate. It can lift the supported glass disc by pressing the support module to avoid the glass disc from being offset when being pressed by the pressing mold, thereby improving its stability.

The pressure plate bracket 81 can be fixedly connected to a vertical column 84 by bolts, and the vertical column 84 is mounted on the disc by bolts through a fixing plate. In this embodiment, the free end of the driving shaft 71 is connected to the bottom surface of the disc.

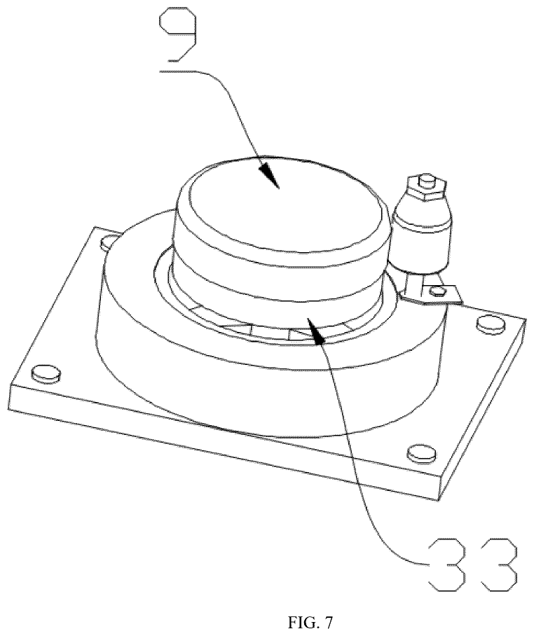

Embodiment 4: a process for preparing culture dishes using flat glass using the pressing device of Embodiment 1, including the following steps:
the production environment of this embodiment is room temperature.
S1: preparing flat glass, and cutting the flat glass into glass discs with diameter requirements and neat outer edges according to the bottom diameter and vertical height of the culture dish by an automatic scriber for later use;
S2: preheating the glass discs to 400° C.-600° C. through the metal strip of a preheating furnace;
S3: placing the preheated glass discs on the pressing mould of the pressing device; controlling the support module 33 to be raised, with partially separated from the through hole 32 of the support base and located below the pressing block 4 (as shown in FIG. 6); the diameter of the support module 33 of the pressing mould used is adapted to the bottom of the culture dish.

More specifically, the support base 32 is provided with a groove 35, the outer diameter of which is slightly larger than or consistent with the outer diameter of the glass disc, so as to place the center of the glass disc corresponding to the center of the support module 33; further, the glass disc and the support module 33 maintain concentricity of 0.2;
the support module 33 is lifted by the first lifting drive mechanism, and the support module 33 is partially separated from the through hole of the support base 32; at the same time, when the top surface of the support module touches the glass disc, a vacuum pump is used to evacuate the glass disc, and the negative pressure provides an adsorption force to the glass disc, thereby improving the stability of the glass disc on the support module;
S4: controlling the support base 32 to rotate by the second rotating drive mechanism to drive the glass discs to rotate; when the glass discs are rotating, using two flame spray gun heads to heat the edge and to be edge-folded portion of the glass discs, until they are red and white respectively;
the to be edge-folded portion corresponds to the intersection of a bottom and a vertical surface of the culture dish; taking a 90 mm diameter culture dish as an example, the range of the folded edge is 18 mm±1 mm, so the melting position is 19 mm from the outer edge of the glass disc to the center. In this step, since the glass discs have been preheated to above 400° C. in step S2, the glass discs will not be broken due to excessive local temperature difference caused by the heating of the flame spray gun; one of the flame spray gun heads is used to melt and heat the edge of the glass disc, so that the sharp straight edge generated when the glass disc is scratched can be changed into a smooth glass round edge.

The heating temperature is controlled at 850-950° C.;

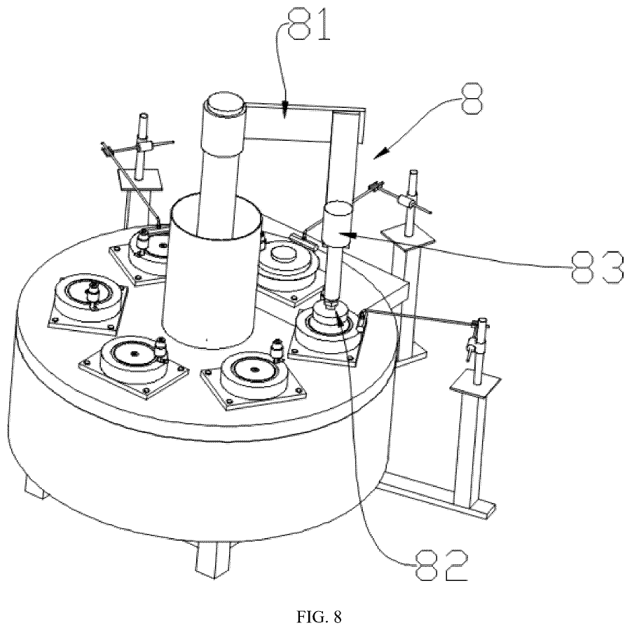

In this step, the flame spray gun head can be held accordingly.
S5: continuing to control the support module 33 to rise until a bottom surface of the pressing block 4 presses the glass disc, and then continuing to lift the support module; under the force of the pressing block 4, the corresponding to be edge-folded portion of the rotating glass disc is deformed, which drives the vertical surface of the corresponding culture dish to turn down 90 degrees; the glass of the turned-down part is completely attached to the side curved surface (that is, the upper and lower heights of the selected support module are greater than the height of the vertical surface of the prepared culture dish, and the height of the support module when lifted is greater than the height of the vertical surface of the prepared culture dish) of the support module; after the vertical surface of the culture dish is formed, continuing to control the support module 33 to rotate horizontally (the support module 33 rotates more than 5 times), and then the culture dish blank is manufactured, as shown in FIG. 7;
in this step, the position of the flame spray gun head at the edge of the glass disc in step S4 remains unchanged and continues to heat, and the flame spray gun head corresponding to the part to be edge-folded stops heating, so that the vertical edge of the culture dish is smoother.

The flame spray gun head of this embodiment uses natural gas mixed with oxygen as fuel.

More specifically, the position of the pressing block can be adjusted so that the position where the pressing block applies force to the glass disc is close to the portion to be edge-folded.
S6: controlling the support module 33 to descend until an inner bottom surface of the glass culture dish blank is separated from the support module 33; after the vacuum pump 311 is turned off, an inner bottom surface of the culture dish blank is separated from the support module 33, and the glass culture dish blank is inverted with an opening facing downward and supported by the support base 32;
S7: transferring the culture dish blank to an annealing furnace plate belt, annealing in the annealing kiln with a length of 20 m, and then gradually reducing the temperature; finally, after leaving the annealing furnace at a temperature of about 80° C., cooling to room temperature to prepare the culture dish.

The flat glass may be a borosilicate glass sheet or a soda-lime glass sheet.

Embodiment 5: a process for preparing culture dishes using flat glass using the pressing device of Embodiment 2 or Embodiment 3, including the following steps:
the production environment of this embodiment is room temperature
S1: preparing flat glass, and cutting the flat glass into glass discs with diameter requirements and neat outer edges according to the bottom diameter and vertical height of the culture dish by an automatic scriber for later use;
S2: preheating the glass discs to 400° C.-600° C. through the metal strip of a preheating furnace;
S3: placing the preheated glass discs on one of the pressing moulds; controlling the support module 33 to be raised, with partially separated from the through hole 32 of the support base and located below the pressing block 4 (as shown in FIG. 6); the diameter of the support module 33 of the pressing mould used is adapted to the bottom of the culture dish.

More specifically, the support base 32 is provided with a groove 35, the outer diameter of which is slightly larger than or consistent with the outer diameter of the glass disc, so as to place the center of the glass disc corresponding to the center of the support module 33; further, the glass disc and the support module 33 maintain concentricity of 0.2;
the support module 33 is lifted by the first lifting drive mechanism, and the support module 33 is partially separated from the through hole of the support base 32; at the same time, when the top surface of the support module touches the glass disc, a vacuum pump is used to evacuate the glass disc, and the negative pressure provides an adsorption force to the glass disc, thereby improving the stability of the glass disc on the support module;
S4: controlling the support base 32 to rotate by the second rotating drive mechanism to drive the glass discs to rotate; when the glass discs are rotating, the disc is driven to rotate; when the disc drives the pressing mould to the position corresponding to the first flame spray gun, the flame spray gun head of the first flame spray gun (the position of the flame spray gun head of the first flame spray gun is adjusted in advance) is used to heat the edge of the corresponding glass disc; the heating temperature is 850-950° C., and the heating time is controlled at 10-30 seconds respectively; continuing to drive the disc to rotate, and when the disc rotates to the position corresponding to the second flame spray gun of the pressing mould, use the flame spray gun head of the second flame spray gun (the position of the flame spray gun head of the second flame spray gun is adjusted in advance) to heat the corresponding part of the glass disc to be edge-folded, and the heating temperature is controlled at 850-950° C., until they are red and white respectively;
the to be edge-folded portion corresponds to the intersection of a bottom and a vertical surface of the culture dish, and the part to be edge-folded corresponds to the intersection of the bottom of the culture dish and the glass of the vertical surface; taking a 90 mm diameter culture dish as an example, the range of the folded edge is 18 mm±1 mm, so the melting position is 19 mm from the outer edge of the glass disc to the center. In this step, since the glass discs have been preheated to above 400° C. in step S2, the glass discs will not be broken due to excessive local temperature difference caused by the heating of the flame spray gun; one of the flame spray gun heads is used to melt and heat the edge of the glass disc, so that the sharp straight edge generated when the glass disc is scratched can be changed into a smooth glass round edge. The other flame spray gun head is aimed at the part of the glass to be bent and deformed to melt it to facilitate its softening.

More specifically, the flame spray gun head of the first flame spray gun is located on the side of the glass disc, and its flame nozzle heats the glass disc horizontally from the side; the flame spray gun head of the second flame spray gun is located above the glass disc, and its flame nozzle heats the glass disc from top to bottom.
S5: driving the disc to rotate, and when the disc rotates and drives the pressing mould to rotate to the position corresponding to the third flame spray gun, continuing to control the support module 33 to rise until a bottom surface of the pressing block 4 presses the glass disc, and then continuing to lift the support module; under the force of the pressing block 4, the corresponding to be edge-folded portion of the rotating glass disc is deformed, which drives the vertical surface of the corresponding culture dish to turn down 90 degrees; the glass of the turned-down part is completely attached to the side curved surface (that is, the upper and lower heights of the selected support module are greater than the height of the vertical surface of the prepared culture dish, and the height of the support module when lifted is greater than the height of the vertical surface of the prepared culture dish) of the support module; after the vertical surface of the culture dish is formed, continuing to control the support module 33 to rotate horizontally (the support module 33 rotates more than 5 times), and then the culture dish blank is manufactured, as shown in FIG. 7;
in this step, a third flame spray gun is used to heat the vertical edge of the culture dish to make the vertical edge of the culture dish smoother.

More specifically, the flame spray gun head of the third flame spray gun is located at the side of the blank of the culture dish, and the flame spray port thereof heats the edge of the vertical surface of the culture dish from the side horizontally.

The flame spray gun head of this embodiment uses natural gas mixed with oxygen as fuel.

More specifically, with regard to Embodiment 3, in this step, when the support module continues to be lifted, the pressing plate is controlled to press the glass disc by adjusting the position of the pressing block, and then is lifted at the same speed as the lifting of the support module.
S6: controlling the support module 33 to descend until an inner bottom surface of the glass culture dish blank is separated from the support module 33; after the vacuum pump 311 is turned off, an inner bottom surface of the culture dish blank is separated from the support module 33, and the glass culture dish blank is inverted with an opening facing downward and supported by the support base 32;
S7: transferring the culture dish blank to an annealing furnace plate belt, annealing in the annealing kiln with a length of 20 m, and then gradually reducing the temperature; finally, after leaving the annealing furnace at a temperature of about 80° C., cooling to room temperature to prepare the culture dish.

The flat glass may be a borosilicate glass sheet or a soda-lime glass sheet.

The invention and the embodiments thereof are described hereinabove, and this description is not restrictive. What is shown in the drawings is only one of the embodiments of the invention, and the actual structure is not limited thereto. All in all, structural methods and embodiments similar to the technical solution without deviating from the purpose of the invention made by those of ordinary skill in the art without creative design shall all fall within the protection scope of the invention.

1. A pressing device for preparing culture dishes using flat glass, wherein:
it comprises a pressing mechanism;
the pressing mechanism comprises at least one pressing mould, and the pressing mould comprises a support base; a center of the support base is provided with a through hole, and a support module is sleeved in the through hole; a lower part of the support module is provided with a rotating lifting mechanism, which can drive the support module to move up and down and perform horizontal rotation;
a top surface of the support base is provided with a cylindrical pressing block.

2. The pressing device for preparing culture dishes using flat glass of claim 1, wherein a center of the support module is provided with a negative pressure hole, which is connected to a vacuum pump via a negative pressure pipe.

3. The pressing device for preparing culture dishes using flat glass of claim 1, wherein the rotating lifting mechanism comprises a first lifting drive mechanism and a first rotating drive mechanism;
the first rotating drive mechanism is located below the first lifting drive mechanism;
the first rotating drive mechanism comprises a motor and a rotating shaft, and the rotating shaft is provided with a mounting plate;
the first lifting drive mechanism and the vacuum pump are mounted on the mounting plate;
the first lifting drive mechanism is an electric lifting rod, and the rod body of the first lifting drive mechanism is hollow; the negative pressure pipe passes through part of the rod body.

4. The pressing device for preparing culture dishes using flat glass of claim 1, wherein it further comprises a base, which comprises a disc that can rotate horizontally;
the pressing mould is mounted on the disc at an equal angle.

5. The pressing device for preparing culture dishes using flat glass of claim 4, wherein it further comprises a pressure plate mechanism, which comprises a pressure plate bracket and a pressure plate.

6. The pressing device for preparing culture dishes using flat glass of claim 5, wherein the pressure plate bracket is provided with a second lifting drive mechanism, which can drive the pressure plate to move up and down.

7. A process for preparing culture dishes using flat glass, including the following steps:
S1: preparing flat glass, and cutting the flat glass into glass discs with diameter requirements and neat outer edges according to the bottom diameter and vertical height of the culture dish by an automatic scriber for later use;
S2: preheating the glass discs to 400° C.-600° C. through the metal strip of a preheating furnace;
S3: placing the preheated glass discs on the pressing mould of the pressing device according to any one of claims 1 to 6; controlling the support module to be raised, with partially separated from the through hole of the support base and located below the pressing block;
S4: controlling the support base to rotate to drive the glass discs to rotate; when the glass discs are rotating, using a flame spray gun head to heat the edge of the glass discs, and using another flame spray gun head to heat the to be edge-folded portion of the glass discs, wherein the to be edge-folded portion corresponds to the intersection of a bottom and a vertical surface of the culture dish;
S5: continuing to control the support module to rise until a bottom surface of the pressing block presses the glass disc, and then continuing to lift the support module; under the force of the pressing block, the corresponding to be edge-folded portion of the rotating glass disc is deformed, which drives the vertical surface of the corresponding culture dish to turn down 90 degrees; the glass of the turned-down part is completely attached to the side curved surface of the support module; after the vertical surface of the culture dish is formed, continuing to control the support module to rotate horizontally, and then the culture dish blank is manufactured;
S6: controlling the support module to descend until an inner bottom surface of the glass culture dish blank is separated from the support module, and the glass culture dish blank is inverted with an opening facing downward and supported by the support base;
S7: transferring the culture dish blank to an annealing furnace plate belt, annealing in the annealing kiln, and then gradually reducing the temperature; finally, after leaving the annealing furnace at a temperature of about 80° C., cooling to room temperature to prepare the culture dish.

8. The process for preparing culture dishes using flat glass of claim 7, wherein in step S5, the support module continues to heat the edge of a vertical surface of the culture dish using a flame spray gun head during the process of rotating and rising.

9. The process for preparing culture dishes using flat glass of claim 7, wherein in step S4, the heating temperature of the flame spray gun head is controlled at 850-950° C.

10. The process for preparing culture dishes using flat glass of claim 7, wherein the flat glass may be a borosilicate glass sheet or a soda-lime glass sheet.
